(19) United States
(12) Patent Application Publication
(10) Pub. No.: US 2026/0087234 A1
(43) Pub. Date: Mar. 26, 2026

(54) ASYNCHRONOUS ELEMENT RENDERING FOR FRONTEND INTERFACES OF COLLABORATION SYSTEMS

(71) Applicant: Atlassian Pty Ltd., Sydney (AU)

(72) Inventors: Stanislav Sysoev, Sydney (AU); Fernando Bordallo, Sydney (AU)

(21) Appl. No.: 18/898,666

(22) Filed: Sep. 26, 2024

(51) Int. Cl. G06F 40/14; G06F 16/176

(52) U.S. Cl. CPC G06F 40/14; G06F 16/176

(57) ABSTRACT

Embodiments relate to systems and methods for dynamically restructuring the element trees of user-editable Hypertext Markup Language (HTML) documents to facilitate asynchronous rendering of certain nodes of those pages via third-party rendering libraries which by design or function impose limitations on asynchronous rendering. Embodiments include a restructuring script that temporarily restructures nodes within the element tree, enabling asynchronous rendering. After rendering, the nodes are restored to their original positions within the document.

### TECHNICAL FIELD

Embodiments described herein relate to cloud-based software platforms with browser-accessible frontends and, in particular, to systems and methods for expanding asynchronous rendering features to third-party script libraries.

### BACKGROUND

An organization can establish a collaborative work environment by providing its employees with access to a suite of discrete web-accessible software platforms to facilitate cooperation and completion of work, for in-office and remote employees alike. Many such software platforms leverage a software stack that includes third-party frontend script libraries to provide a consistent user experience across multiple browsers and browser technologies.

However, although use of third-party frontend script libraries can accelerate development and adoption of new web technologies, such libraries cannot anticipate or support all potential use cases. For example, many libraries may only support asynchronous rendering of nodes, components, or elements up to a certain depth of a document tree. In these examples, many nodes may be rendered synchronously, increasing page load times.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a system diagram of a software platform as described herein.

FIG. 2 depicts a graphical user interface defined at least in part by operation of one or more third-party script libraries.

FIG. 3 depicts a simplified instance diagram of a browser rendering a hypertext markup language (HTML) document including nodes requiring rendering by one or more third party script libraries.

FIG. 4A depicts a simplified instance diagram of the browser of FIG. 3, restructuring the document tree prior to rendering by a third-party script library.

FIG. 4B depicts the simplified instance diagram of the browser of FIG. 4A, restructuring the document tree after rendering by the third-party script library.

FIG. 5 depicts a simplified instance diagram of a browser rendering an HTML document, batch restructuring the document tree prior to rendering by a third-party script library.

FIG. 6 is a flowchart depicting example operations of a method of restructuring a page tree of an HTML document prior to rendering to support asynchronous element rendering, as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems and methods for dynamically restructuring element trees of user-editable hypertext markup language (HTML) documents in order to asynchronously render (e.g., render in parallel) certain nodes of those element trees via third-party rendering libraries that, by design or limitation, impose restrictions on asynchronous rendering. Once rendered, the nodes can be returned to original locations within the element tree.

As a result of the rendering techniques as described herein, an HTML document of arbitrary user-defined complexity can be asynchronously rendered, independent of limitations imposed by third-party rendering libraries. In this manner, developers of web services or platforms (that may be required by their organization to leverage third-party rendering libraries) can dedicate more resources to developing key platform-differentiating features, without risking unexpected user experience degradation.

More simply, some web services are specifically designed to permit users to edit, create, or modify content. In addition, some web services are designed to render one or more graphical user interface elements, such as buttons, switches, badges, or avatars within page content. In some cases, a single web application may depend upon multiple third-party script libraries, from multiple different third parties.

An example may be a documentation platform that includes a rich text editor and stylized user interface elements, such as buttons, avatars, and badges. A first script library may support rendering of the stylized user interface elements and a second script library may support features and functionality of the rich text editor. As a result of this combined functionality, a user of the documentation platform may be equipped to edit, structure, and format text, while also being equipped to insert into that formatted text, stylized user interface elements, such as badges, switches, icons, links, media, or avatars.

In these examples, once a user pushes or publishes changes to a particular document, that document can be viewed as an HTML document by the same user or other users of the documentation platform. More specifically, the user's design and formatting decisions—which may include rich, formatted text alongside one or more custom user interface elements—inform how the resulting HTML page will be structured and rendered in response to subsequent requests.

However, in many cases, embedding an object associated with, managed, or created by one script library into an object associated with, managed or created by another script library results in inefficient synchronous (e.g., sequential) rendering. For example, continuing the foregoing, stylized user interface elements embedded into a rich text editor section may be interpreted by the stylized user interface element script library as sub-elements of a single root element. In this example, the script library may be specifically configured to render the “root” element asynchronously with other stylized user interface elements outside the rich text editor section, resulting in each “sub-element” below the root element to be rendered in sequence. As a result of this third-party imposed limitation, a user that creates a rich-text document with a large number of embedded stylized elements unintentionally creates content that when represented as an HTML document is forced to be substantially rendered one element at a time.

The embodiments described herein overcome these third-party limitations by restructuring HTML documents that include nested sections of content managed, rendered, or styled by different third-party script library. More specifically, embodiments described herein reference methods of dynamically restructuring an element tree of an HTML document to gather and/or batch nodes associated with a first script library below a one or more temporary parent nodes (or higher ancestor) nodes such that each temporary parent node can be rendered asynchronously with other page content. Once rendering of each parent node is complete, the rendered elements can be returned to their original locations within the element tree of the original HTML document.

To continue the previous example, when a user requests an HTML document from the documentation platform that includes a large number of stylized user interface elements embedded within a rich text editor object, the HTML document may be served with three script libraries. The first script library may be the stylized user interface element script library. The second script library may be the rich text editor library. The third script library may be a script configured to restructure the HTML page to extract stylized user interface elements embedded within a rich text editor section to depend from a temporary ancestor node. As a result of the reordering of elements, the first script library may render each ancestor node asynchronously, thereby rendering each previously-embedded stylized interface element. Once each element is rendered, the third script can be configured to replace each now-rendered element to its original position within the element tree of the HTML page.

Broadly, embodiments described herein dramatically improve rendering times and reduce processor and memory utilization at end-user computing devices for users of web-based software platforms.

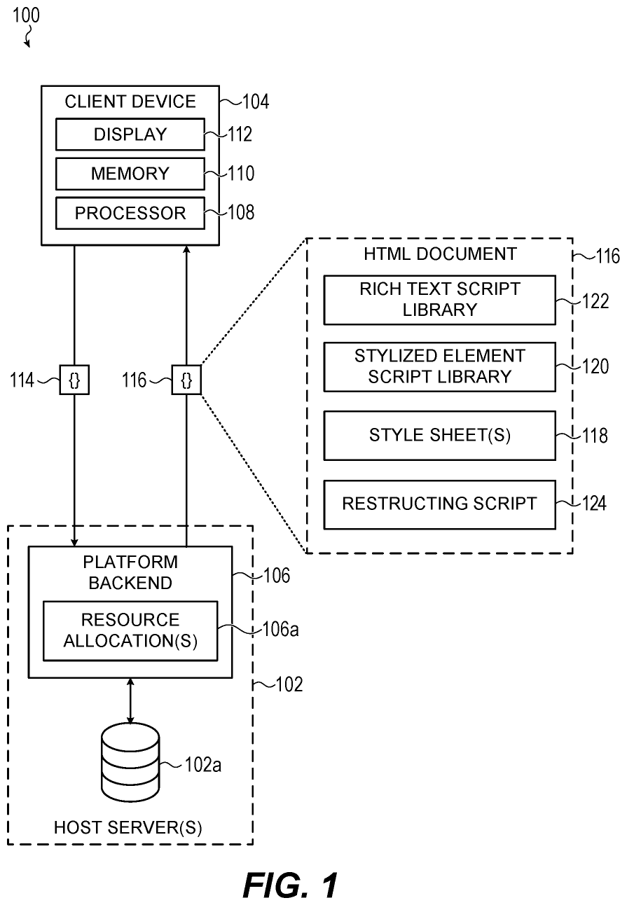

These foregoing and other embodiments are discussed below with reference to FIGS. 1-6. However, those skilled in the art will readily appreciate that the detailed description given herein with respect to these figures is for explanation only and should not be construed as limiting.

FIG. 1 depicts a system diagram of a software platform configured as a web service, as described herein. In many embodiments, the web services platform 100 can be configured to operate over one or more host servers (the host servers 102) to provide a software service defined at least in part by cooperation of a frontend application instance and a backend application instance. The frontend application instance can be instantiated over resources of a client device 104, and the platform backend 106 can be instantiated over resources of the host servers 102. The platform backend 106 may be configured to store user generated content, organize user generated content, and/or perform one or more data operations against user generated content.

As noted above, the web services platform 100 includes the host servers 102 which can be one or more physical servers co-located or geographically across more than one location. The host servers 102 can include one or more processing resources (e.g., processors) and one or more memory resources that can be shared or allocated to one or more processes, threads, or instances of software. In some cases, resources of the host servers 102 can be leveraged to instantiate one or more virtual machines that in turn can instantiate one or more software services that perform one or more functions of the web services platform 100, including facilitating communications with a client device 104.

In some configurations, the host servers 102 can define a virtual machine in which the platform backend 106 can be instantiated to receive requests from and/or to provide responses to the client device 104. For example, the virtual machine can instantiate one or more instances of the platform backend 106. The virtual machine can have dedicated to it one or more processing resources and memory resources of the host servers 102, specifically identified in FIG. 1 as the resource allocations 106a.

The platform backend 106 is configured to communicably couple to a corresponding frontend application instance executing on the client device 104. Specifically, the client device 104 can include a processor 108, a memory 110, and a display 112. The processor 108 and the memory 110 can cooperate to instantiate the frontend application instance which is, in turn configured to communicate with the host servers 102 and, in particular to the platform backend 106.

In these configurations, the client device 104 can be configured to instantiate a browser application (more generally, the “frontend application instance”) by cooperation of the processor 108 and the memory 110. The browser application can leverage the display 112 to render HTML documents and other web services content for a user of the client device 104.

For example, the browser application can generate a request 114 addressed to the host servers 102. A gateway of the host servers 102 can receive the request 114 and direct it to the platform backend 106. In response, the platform backend 106 can query a database 102a to retrieve content identified by and/or associated with the request 114. In many cases, the platform backend 106 can retrieve from the 102a one or more content items and can package those content items as a response 116.

As noted above, the response 116 can be structured according to the HTML format, which may include one or more embedded styles, scripts, or structured data objects. In many cases, as noted above, the response 116 can include one or more imports or links, such as one or more style sheets 118 and one or more scripts or script libraries. For example, as noted above, in many configurations the platform backend 106 can be configured to serve HTML documents that leverage one or more third-party technology stacks, such as a script library for rendering stylized user interface elements or a script library for providing feature-rich specific functionality, such as rich text editing functionality.

In the illustrated embodiment, the response 116 may be or include an HTML-formatted document that includes at least two third party script libraries as imports. Specifically, the response 116 can include a first library for rendering (and providing functionality and/or visualizations in respect thereof) stylized user interface elements and a second library for providing rich text editing features. In FIG. 1, the response 116 includes a stylized element script library 120 and a rich text script library 122 structured according to a page structure.

In this example, the response 116 can be received by the browser application and may be rendered by one or more browser engines. More specifically, the response 116 can cause the processor 108 and the memory 110 to render a web page with functionality, style, and structure defined according to the response 116.

As with other embodiments described herein, the stylized element script library 120 and the rich text script library 122 may be associated with specific elements of an element tree defined by a page structure. For example, the page structure can include a number of elements having classes and/or identifiers enumerable by the stylized element script library 120. Similarly, the page structure can include one or more sections configured to receive user input in the form of formattable, style-able text (i.e., rich texts). These sections can likewise be associated with elements of the same element tree having types, classes, and/or identifiers enumerable by the rich text script library 122. More broadly, the rich text script library 122, once instantiated and/or loaded by the browser of the client device 104, may operate to render one or more rich text areas (and associated elements, such as formatting affordances) and the stylized element script library 120, once instantiated and/or loaded by the browser of the client device 104 may operate to render one or more stylized elements, such as buttons, icons, avatars and the like.

In some examples, the rich text script library 122 and the stylized element script library 120 may be third party libraries that impose intentional or functional restrictions on the order or manner by which elements associated with those respective library are rendered. For example, the stylized element script library 120 may be designed to support asynchronous rendering of elements only to a certain element tree depth. In one example, the stylized element script library 120 may only asynchronously render root elements. In a circumstance in which a group of stylized elements are embedded within a parent stylized element, the embedded elements may be required to be rendered in sequence.

This rigidly-define rendering schema may result in poor performance and delayed load times for certain pages. For example, in some embodiments, the web services platform 100 is configured to operate as a documentation platform. In these examples, the client device 104 may make page requests of the platform backend 106 which can return in response an HTML document that defines structured pages with stylized elements alongside one or more rich text editing sections (to receive user input, user comments, and the like). For example, a page returned by the documentation platform can include a header and a footer, each with one or more buttons, icons, menus, and the like each having functionality or style defined by the stylized element script library 120. To provide a consistent user experience and impression across the entire page, the documentation platform can also stylize one or more rich text editing sections—functionality of which is provided by the rich text script library 122—with the stylized element script library 120. In these embodiments, a rich text editing section supported by the rich text script library 122 may itself be defined as a node or element of the stylized element script library 120.

As a result of these constructions, any stylized element embedded within a rich text editing section becomes a descendent element of an ancestor element, both of which are configured to be rendered and/or managed by the stylized element script library 120. As noted above, intentional or functional limitations of third party rendering libraries render descendent elements (i.e., elements depending upon an ancestor or root element) sequentially. This limitation of third party libraries may result in significant page load times for the documentation platform—and/or other configurations of the web services platform 100—if users insert a number of stylized elements within a rich text editing area.

It may be appreciated that restructuring a third party library such as the stylized element script library 120 and/or the rich text script library 122 may not be practical or desirable in many circumstances. Accordingly embodiments described herein configure the platform backend 106 to serve with the response 116 a restructuring script 124 configured to temporarily reorganize the relationships between elements of the HTML document defined in the response 116. More particularly, the restructuring script 124 may be configured to identify one or more elements associated with a first script library such as the stylized element script library 120 that are arranged in the element tree in a manner that causes the stylized element script library 120 to render such elements sequentially. Upon enumerating such elements, the restructuring script 124 can be configured to extract those elements to a level or depth within the element tree for which the stylized element script library 120 can render asynchronously. Thereafter, once the elements are rendered, they may be placed back into original locations within the element tree. As a result, embodiments described herein can render any arbitrary number of stylized elements, positioned at any arbitrary depth in an element tree, asynchronously despite that such functionality is not supported by the underlying third-party library performing that rendering.

These foregoing embodiments depicted in FIG. 1 and the various alternatives thereof and variations thereto are presented, generally, for purposes of explanation, and to facilitate an understanding of various configurations and constructions of a web services platform and the embedded or linked scripts of pages served therefrom, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, in some embodiments, embedded elements extracted by a restructuring script may be batched into common temporary parent elements. For example, if one hundred independent elements are extracted by a restructuring script from a particular page served by a platform backend as described herein, five temporary elements can be created each of which may include twenty element batches of the extracted one hundred elements. This is merely an example, many constructions are possible.

Further, in some embodiments, a page can be served from a platform backend with a page structured without embedded elements. In these examples, a restructuring script such as the restructuring script 124 can be configured to restructure a page only after elements have been rendered. More particularly, such a script can be configured to move elements after rendering into an intended position within a document object model (DOM) of the HTML page received by the client device 104.

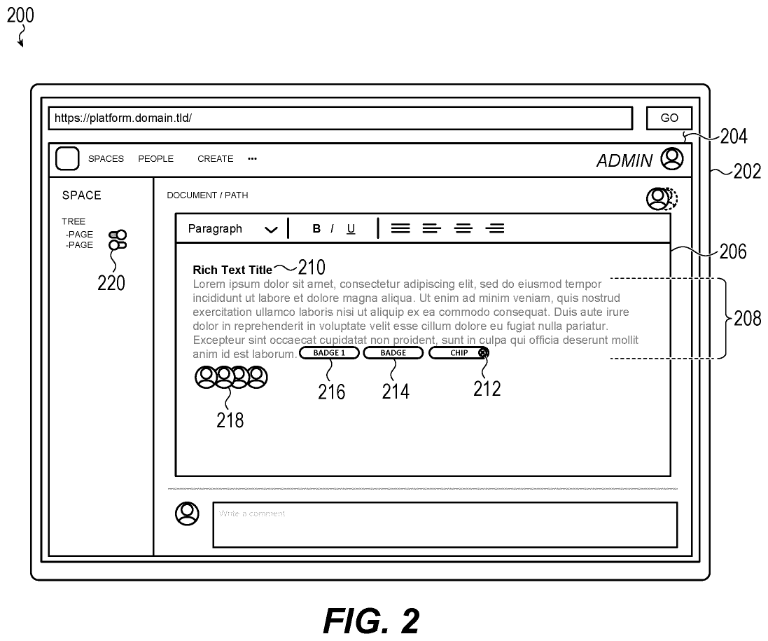

FIG. 2 depicts a graphical user interface defined at least in part by operation of one or more third-party script libraries, such as described above in reference to FIG. 1. In this example, a client device 200 includes a display 202 that can be leveraged by an instance of a frontend application associated with a web-based documentation platform to render a graphical user interface 204.

More simply, the graphical user interface 204 can be rendered by the client device 200 in response to receiving an HTML document from a backend application instance associated with the frontend application instance. In the illustrated embodiment, the graphical user interface 204 renders elements associated with a collaborative documentation platform with which two or more users can edit text, format text, and insert special stylized objects into that text. As with other embodiments described herein, pages served by a backend application instance to the frontend application instance can include and/or link to one or more third-party script libraries, such as a first script library supporting rich text editing and a second script library supporting consistent rendering of stylized elements of the page, such as cross-linking views or cross-platform embedded content views.

In these constructions, common interface features of the graphical user interface 204, such as headers, menus, page tree views, and the like, can be rendered by operation of a stylized element script library and rich text editing areas can be rendered by operation of a rich text editing library, each of which may be linked by and/or embedded with an HTML document served to the graphical user interface 204.

For example, the graphical user interface 204 can include a rich text editing area 206 into which a user can insert content in the form of formatted text, such as the paragraph 208 or the bold title 210.

The graphical user interface 204 can also include one or more special stylized elements rendered by a stylized element rendering library. These stylized elements may be within (i.e., embedded) the rich text editing area 206 or separate from the rich text editing area 206. For example, a chip element 212, the badge elements 214, 216 and several user avatars, shown as the avatar group 218, can be embedded within the rich text editing area 206. In other cases, media or cross-links can be embedded. Other elements, such as the switches 220 may be external to the rich text editing area 206.

As a result of this page design, as described above, default operation of the stylized element rendering library may render the chip element 212, the badge elements 214, 216 and the avatar group 218 in sequence, which may be inefficient. To counter this behavior, a restructuring script can withdraw the chip element 212, the badge elements 214, 216 and the avatar group 218 to a parent element at the same page tree depth as the switches 220 such that substantially all elements rendered by the stylized element rendering library render asynchronously.

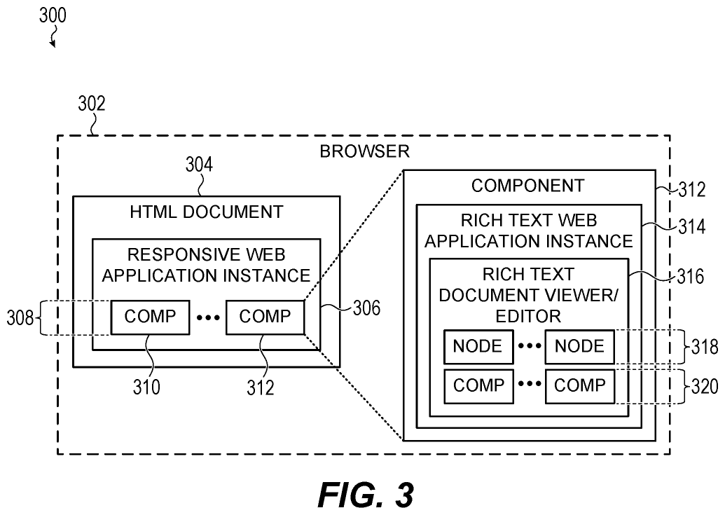

FIG. 3 depicts a simplified instance diagram 300 of a browser 302 rendering an HTML document 304 including nodes requiring rendering by one or more third party script libraries. In this example, the HTML document 304 includes at least two different types of user interface elements that may be rendered by different third-party script libraries. In this example, the HTML document 304, once parsed by an element parser into a document object model (DOM), can load two or more third party script libraries.

A first script library, once executed can cause to be instantiated an instance of a responsive web application 306 responsible for stylized rendering of one or more user interface components (e.g., buttons, menus, icons, and the like) and for defining functionality associated with those user interface components, collectively identified as the components 308. Example components that may be rendered by operation of the responsive web application 306 include but are not limited to, buttons, badges, menus, headings, images, media, links, media previews, link previews, clips and the like. The components 308 can include a component 310 and a component 312. As a result of the arrangement of the component 310 and the component 312 within a similar or equivalent level of the DOM representing the HTML document 304, the component 310 and the component 312 may be rendered asynchronously relative to one another.

For certain configurations of the HTML document 304, the responsive web application 306 can include a component having inner content that is stylized and/or otherwise supported by a second script library, such as a script library supporting rich text editing. In this example, like with the responsive web application 306, once the second script library is instantiated, an instance of a rich text web application 314 may be created in browser memory. In this architecture, the rich text web application 314 is a sub element of the component 312 that, itself, is an element associated with the responsive web application 306. The rich text web application 314 can include one or more sub elements as well, such as one or more rich text editor views or user input sections, such as the rich text document viewer 316.

The rich text document viewer 316 can include sub elements specific to functionality of the rich text web application 314, such as text regions, sections, or styles (e.g., bold text, paragraphs, headers, lists, and the like). Collectively, these sub elements are represented in FIG. 3 as the nodes 318. In some cases, the rich text document viewer 316 can also include one or more sub elements configured to be rendered and functionally supported by the responsive web application 306. Collectively, these sub elements of the rich text web application 314, are represented in FIG. 3 as the components 320. As noted with respect to other embodiments described herein, default configuration of the responsive web application 306 may cause the components 320 to render sequentially specifically because those elements are descendent elements of the component 312.

As a result, although the component 310 and the component 312 are rendered asynchronously relative to each other, each sub-element of the component 312 renders sequentially. More specifically, each of the components 320 render one at a time, thereby increasing the overall rendering time of the component 312 significantly beyond that of the component 310.

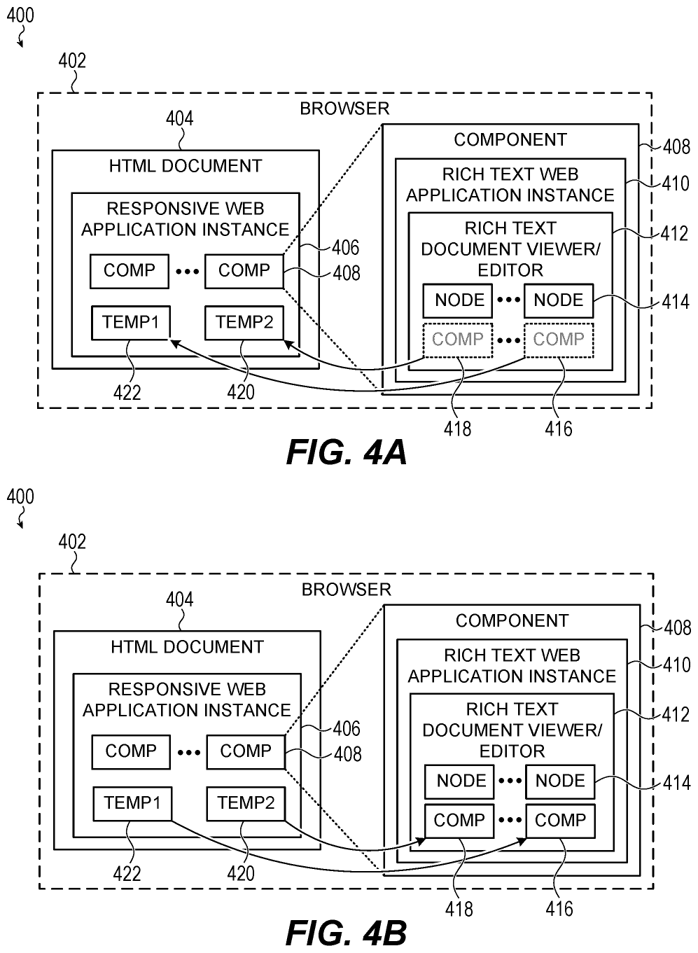

FIG. 4A depicts a simplified instance diagram of the browser of FIG. 3, restructuring the document tree prior to rendering by a third-party script library. This depicted embodiment includes the simplified instance diagram 400 of a browser 402 rendering the HTML document 404, which includes nodes and components associated with two or more third party script libraries.

As with FIG. 3, the browser 402 can be configured to load a first script library and a second script library, each of which once loaded causes instantiation of respective web applications parts exhibiting specific user-facing functionality. For example, a responsive web application 406 may be responsible for stylized rendering of one or more user interface elements (e.g., buttons, menus, icons, and the like) and for defining functionality associated with those user interface elements. At least one of the components of the responsive web application 406 may have embedded therein a rich text editor element, such as an element that can be created and/or supported by a rich text web application instance 410 that is associated with a rich text document viewer 412.

As with FIG. 3, the rich text document viewer 416 can include sub elements specific to functionality of the rich text web application 412, such as text regions, sections, or styles (e.g., bold text, paragraphs, headers, lists, and the like). Collectively, these sub elements are represented in FIG. 4 as the nodes 414. In some cases, the rich text document viewer 412 can also include one or more sub elements configured to be rendered and functionally supported by the responsive web application 406, such as the components 416 and 418.

As noted with respect to other embodiments described herein, default configuration of the responsive web application 406 may cause the components 420 to render sequentially specifically because those elements are descendent elements of the component 408. To overcome this limitation, a restructuring script can be included within the HTML document 404 that removes the components 416, 418 to depend from temporary nodes 420, 422 created within the DOM representing the HTML document 404. As a result of this restructuring, the responsive web application 406 renders the temporary node 420 and the temporary node 422 asynchronously with other components of the responsive web application 406. Once the rendering finishes, these rendered elements can be returned to depend from the rich text document viewer 412, such as shown in FIG. 4B.

These foregoing embodiments depicted in FIGS. 2-4B and the various alternatives thereof and variations thereto are presented, generally, for purposes of explanation, and to facilitate an understanding of various configurations and constructions of a web services platform and the embedded or linked scripts of pages served therefrom, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

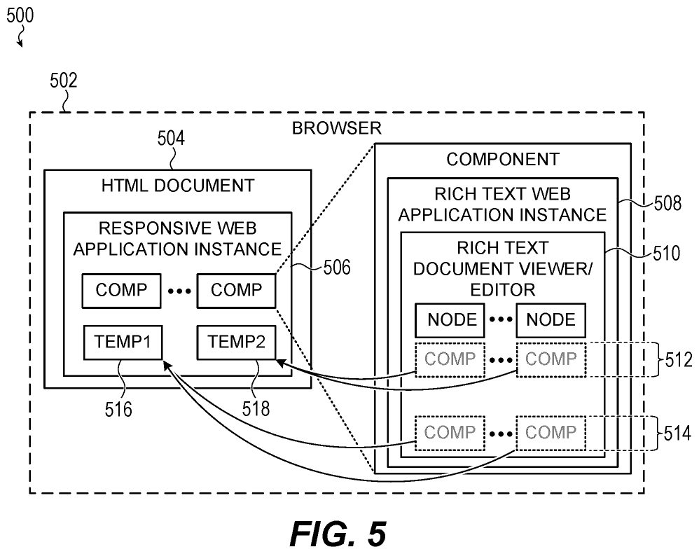

For example, in some embodiments, restructured sub elements/components can be batched for rendering. FIG. 5 depicts a simplified instance diagram 500 of a browser 502 rendering an HTML document 504 that imports multiple libraries, including a responsive web application 506 and a rich text web application instance 508. Prior to rendering all elements of the responsive web application 506, subcomponents of a rich text document viewer 510, such as the components 512, 514 can be removed in batches to temporary parent elements 516, 518. More specifically, a restructuring script can be configured to reposition multiple components into a single temporary parent element. In this construction, the temporary parent elements 516, 518 can render asynchronously with other higher-order components of the responsive web application 506.

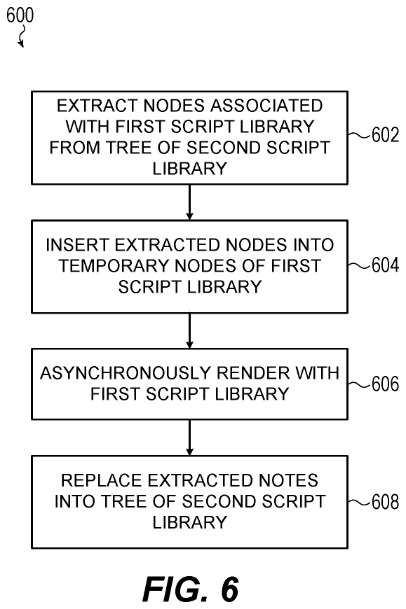

FIG. 6 is a flowchart depicting example operations of a method of restructuring a page tree of an HTML document prior to rendering to support asynchronous element rendering, as described herein. The method 600 includes operation 602 at which one or more nodes of an HTML element tree associated with a first script library are extracted from a tree section associated with a second script library. This operation can be performed prior to transmitting an HTML document to a recipient client device (e.g., reorganization/restructuring can be performed by a backend application instance). In other embodiments, this operation can be performed by a restructuring script as described herein.

The method 600 further includes operation 604 at which the extracted nodes or components are inserted into one or more temporary nodes inserted into the DOM representation of the HTML document parsed at operation 602.

At operation 606, components associated with the first script library can be rendered asynchronously. Finally, at operation 608, the now-rendered elements can be removed from the temporary nodes and can be re-inserted into the prior DOM locations. In some cases, identifiers can be appended to each extracted node that identify positions or parent elements into which the elements should be re-inserted upon rendering. Thereafter, temporary nodes can be discarded or otherwise hidden, removed, or excluded.

This is merely one example, in other cases, a restructuring script as described herein can be configured to maintain an association table in memory to link destination locations with individual elements.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

Furthermore the foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method for asynchronous rendering of hypertext markup language (HTML) elements with a rendering library configured for synchronous rendering, the method comprising:
receiving, at a browser application instantiated by cooperation of a processor and memory of a client device communicably coupled to a host server, an HTML document received from a backend application instantiated by the host server, the HTML document referencing:
a first script library defining functionality and style of at least one HTML element class; and
a second script library defining functionality of a rich text editor section of the HTML document;
determining that inner content of the rich text editor section comprises a set of HTML elements of the at least one HTML element class;
creating a set of temporary ancestor nodes separate from the rich text editor section;
removing the set of HTML elements from the rich text editor section and dividing the set of HTML elements among the set of temporary ancestor nodes;
causing the first script library to asynchronously render each temporary ancestor node;
receiving as output of the first script library a set of rendered HTML elements;
inserting the set of rendered HTML elements into the rich text editor section; and
rendering the HTML document at the browser application.

2. The method of claim 1, wherein the HTML document comprise or references a third script library, the third script library configured upon execution to:
determine that inner content of the rich text editor section comprises the set of HTML elements;
create the set of temporary ancestor nodes;
remove the set of HTML elements from the rich text editor section;
divide the set of HTML elements among the set of temporary ancestor nodes; and
provide the set of temporary ancestor nodes as input to the first script library to asynchronously render each temporary ancestor node.

3. The method of claim 2, wherein the HTML document embeds at least one of the first script library and the second script library.

4. The method of claim 1, wherein each element of the set of HTML elements is configured to be styled by the first script library.

5. The method of claim 1, wherein each of the set of temporary ancestor nodes are rendered by the first script library in parallel with other HTML elements of the HTML document.

6. The method of claim 1, wherein the rich text editor section is a node having the at least one HTML element class.

7. The method of claim 1, wherein the HTML document defines a frontend user interface of a documentation platform.

8. The method of claim 1, wherein dividing the set of HTML elements among the set of temporary ancestor nodes comprises evenly distributing the set of HTML elements among the set of temporary ancestor nodes.

9. The method of claim 1, wherein the first script library is a third-party script library.

10. A computer-implemented method for parallel rendering of hypertext markup language (HTML) elements by a browser application, the method comprising:
receiving, at the browser application, an HTML document referencing a third-party script library defining style of at least one HTML element class;
determining that inner content of at least one section of the HTML document comprises a set of HTML elements of the at least one HTML element class that, based on position within an element tree of the HTML document, will render synchronously;
creating a set of temporary ancestor nodes separate from the at least one section;
extracting the set of HTML elements from the at least one section;
dividing the set of HTML elements among the set of temporary ancestor nodes;
providing the set of temporary ancestor nodes as input to the third-party script library to render each temporary ancestor node in parallel;
receiving as output of the first script library a set of rendered HTML elements;
inserting the set of rendered HTML elements into prior locations thereof within the at least one section; and
discarding the set of temporary ancestor nodes and displaying the rendered HTML document.

11. The method of claim 10, wherein the third-party script library further defines functionality of the at least one HTML element class.

12. The method of claim 10, wherein:
the third-party script library is a first third-party script library; and
the at least one section has a style or a function defined by a second third-party script library referenced by the HTML document.

13. The method of claim 10, wherein the HTML element class defines a button, badge, or user interface element.

14. The method of claim 10, wherein dividing the set of HTML elements among the set of temporary ancestor nodes comprises dividing the set of HTML elements evenly among the set of temporary ancestor nodes.

15. The method of claim 10, wherein the at least one section defines a rich text editor section of the HTML document.

16. A computer-implemented method for asynchronous rendering of hypertext markup language (HTML) elements with a rendering library configured for synchronous rendering, the method comprising:
receiving, at a browser application instance, an HTML document received from a backend application instance;
determining that inner content of a section of the HTML document comprises a set of HTML elements of at least one HTML element class that the rendering library will cause to be rendered synchronously;
creating a set of temporary ancestor nodes separate from the section;
removing the set of HTML elements from the section;
distributing the set of HTML elements among the set of temporary ancestor nodes;
providing the set of temporary ancestor nodes as input to the rendering library to asynchronously render each temporary ancestor node;
receiving as output of therendering library a set of rendered HTML elements; and
inserting the set of rendered HTML elements into respective original locations thereof.

17. The method of claim 16, comprising discarding the temporary ancestor nodes after inserting the set of rendered HTML elements back into the respective original locations thereof.

18. The method of claim 16, wherein the rendering library is a third-party script library referenced by the HTML document.

19. The method of claim 16, wherein the section comprises functionality defined by a script library referenced by the HTML document.

20. The method of claim 16, wherein distributing the set of HTML elements among the set of temporary ancestor nodes comprises dividing the set of HTML elements evenly among the set of temporary ancestor nodes.
